(19) United States
(12) Patent Application Publication
(10) Pub. No.: US 2024/0215761 A1
(43) Pub. Date: Jul. 4, 2024

(54) FRYING APPARATUS CAPABLE OF REMOVING RETAINED SEDIMENT AND CIRCULATING AND REPLENISHING FILTERED FRYING OIL

(71) Applicants: CISPIA TECH. CO., LTD., Gyeonggi-do (KR); SK Japan Co., Ltd., Fukuoka (JP)

(72) Inventor: Jun Ho SHIN, Gyeonggi-do (KR)

(21) Appl. No.: 18/605,969

(22) Filed: Mar. 15, 2024

Related U.S. Application Data
(63) Continuation of application No. PCT/KR2021/014496, filed on Oct. 18, 2021.

(30) Foreign Application Priority Data
Sep. 16, 2021 (KR) 10-2021-0123643

(51) Int. Cl. A47J 37/12; B01D 29/27; B01D 29/90

(52) U.S. Cl. CPC A47J 37/1223; A47J 37/129; B01D 29/27; B01D 29/902; B01D 2201/0415

(57) ABSTRACT

A frying apparatus includes: a main body provided with a first casing portion and a second casing portion located behind and above the first casing portion; a frying oil tank installed in the first casing portion, and provided with a central discharge port located close to a bottom surface of the frying oil tank, and with supply ports arranged at upper portions of both sides of the discharge port; a filter member installed in the second casing portion; and a frying oil filtration unit provided with a circulation piping installed to connect the discharge port and the supply ports while passing through the filter member, and with a motor pump that is installed on the circulation piping, and that suctions and pumps frying oil in the oil tank to circulate and replenish the frying oil, which has passed through the filter member, into the oil tank.

### CROSS-REFERENCE TO RELATED APPLICATIONS

This application is a continuation application of International Patent Application No. PCT/KR2021/014496 filed on Oct. 18, 2021, which claims priority to Korean Patent Application No. 10-2021-0123643 filed on Sep. 16, 2021, the entire contents of which are incorporated by reference.

### TECHNICAL FIELD

The present invention relates to a frying apparatus capable of removing accumulated sediments and circulating and replenishing filtered frying oil, particularly to a frying apparatus in which a bottom surface of an frying oil tank is formed with an inclined structure that is fluid-dynamically designed in accordance with discharge and supply flow directions of frying oil in the oil tank, and which can keep the frying oil in the oil tank clean for a longer period of time by naturally discharging all accumulated sediments in the oil tank and filtering the frying oil, and then circulating and replenishing the filtered frying oil into the oil tank.

### BACKGROUND ART

Fried dishes are cooked by dipping and frying various foods in high-temperature frying oil, and frying ingredients are often cooked while being coated with flour, frying powder, or the like.

In order to cook using such a frying method, commercial establishments use a large-capacity frying machine, and in the commercial frying machine, in a state where frying oil such as cooking oil is put in an oil tank with a built-in heater, the frying oil is heated, and then an ingredient is added, thereby completing a fried dish.

Since the texture and taste of a fried dish can only be improved by quickly frying a frying ingredient at an optimal temperature, in the commercial frying machine of the related art, a focus has been placed on frying a large amount of the ingredient more quickly and swiftly.

Meanwhile, inside the oil tank in which fry cooking is performed, residues removed from the frying ingredient, residues burned due to the heat exposure thereof over a long period of time, and foreign substances introduced from the outside are mixed and remain as impurities.

The frying oil (cooking oil) mixed with the impurities in such a manner spoils easily, and when reused, the oxidation of the frying oil itself occurs, thereby not only making the frying oil unusable and contaminating the frying ingredient, but also causing the color of the fried dish to become dark and deteriorating the taste. Therefore, it is important to periodically replace the frying oil while keeping the frying oil in the oil tank as clean as possible.

Accordingly, changing the frying oil frequently is advantageous in keeping the frying oil clear; however, when the frying oil is replaced too frequently, the cost burden associated with the frying oil increases to that extent. Therefore, a user can keep the frying oil as clean as possible within an appropriate usage limit of the frying oil through the management of the frying oil by scooping and removing the impurities contained in the frying oil using a kitchen strainer.

Incidentally, the impurities in the oil tank not only float in the frying oil, but also settle and float on the bottom of the oil tank, and when a large-capacity frying machine for commercial establishment is used, it is not only very difficult to scoop and remove the impurities, which are settled deep in the oil tank, using a kitchen strainer, but also there is a high risk of occurrence of a safety accident such as burns, whereby it is not easy to remove the settled impurities, which is a problem.

As the related art to solve such a problem, there is Korea Patent No. 10-1211833, and according to the patent, an automatic filtration device that automatically filters and processes cooking oil in a frying tank is provided.

The automatic filtration device includes a fluid pump that suctions and pumps the cooking oil in the frying tank, and a filter member that filters the cooking oil pumped by the fluid pump. The replacement period of the cooking oil can be extended and the cooking oil can be kept as clean as possible by causing the filtered cooking oil to return to the frying tank, and by filtering and reusing the cooking oil.

Incidentally, according to the patent, only settled impurities in the vicinity of a discharge port through which the cooking oil is discharged are mainly suctioned, and there is a limitation on suctioning and filtering all impurities settled in the entirety of the large-capacity oil tank.

### SUMMARY OF INVENTION

### Technical Problem

Accordingly, the present invention has been made to solve the above-described problems, and an object of the present invention is to provide a frying apparatus in which a bottom surface of a frying oil tank is formed with an inclined structure that is fluid-dynamically designed in accordance with discharge and supply flow directions of frying oil in the frying oil tank, and which can keep the frying oil in the oil tank clean for a longer period of time by naturally discharging all accumulated sediments in the oil tank and filtering the frying oil, and then circulating and replenishing the filtered frying oil into the oil tank.

### Solution to Problem

In order to achieve the above-described object, a frying apparatus according to the present invention is characterized by including:
a main body provided with a first casing portion and a second casing portion located behind and above the first casing portion;
a frying oil tank installed in the first casing portion, and provided with a central discharge port located close to a bottom surface of the frying oil tank, and with supply ports arranged at upper portions of both sides of the discharge port;
a filter member installed in the second casing portion; and
a frying oil filtration unit provided with a circulation piping installed to connect the discharge port and the supply ports while passing through the filter member, and with a motor pump that is installed on the circulation piping, and that suctions and pumps frying oil in the oil tank to circulate and replenish the frying oil, which has passed through the filter member, into the oil tank.

In addition, the frying apparatus according to the present invention is characterized in that
the filter member includes a mesh basket and a filter paper covered with the mesh basket, and is attachable to and detachable from the second casing portion, and
in that the main body includes covers that open and close a front surface and an upper surface of the second casing portion.

In addition, the frying apparatus according to the present invention is characterized in that
a lower end of the front cover of the second casing portion is hinge-coupled to the second casing portion, so that the front cover is openable and closable by rotating upward and downward, in that the filter member is detachably coupled to the front cover, and
in that a downward opening angle of the front cover is limited to less than 90 degrees.

In addition, the frying apparatus according to the present invention is characterized in that
the bottom surface of the oil tank includes horizontal bottom portions connected forward from the supply ports, an inclined bottom portion connected in a manner as to be inclined downward and rearward toward the discharge port between the horizontal bottom portions, and inclined side wall portions connected in a manner as to be inclined downward and inward between the horizontal bottom portions and the inclined bottom portion.

### Advantageous Effects of Invention

In the frying apparatus according to the present invention,
the bottom surface of the frying oil tank includes the horizontal bottom portions connected forward from the supply ports of the oil tank, the inclined bottom portion connected in a manner as to inclined downward and rearward toward the discharge port of the oil tank between the horizontal bottom portions, and the inclined side wall portions connected in a manner as to be inclined downward and inward between the horizontal bottom portions and the inclined bottom portion, the bottom surface of the frying oil tank is formed with an inclined structure that is fluid-dynamically designed in accordance with discharge and supply flow directions of the frying oil in the oil tank, and the frying oil in the oil tank can be kept clean for a longer period of time by naturally discharging all accumulated sediments in the oil tank and filtering the frying oil, and then circulating and replenishing the filtered frying oil into the oil tank.

The following effects of the present invention are obtained. The filter member including the mesh basket and the filter paper covered with the mesh basket is formed to be attachable and detachable, so that the separation and discharge of the filtered accumulated sediments and the replacement of the filter paper can be made convenient.

Since the filter member is detachably coupled to the front cover that is opened and closed by rotating upward and downward, and the downward rotation opening angle of the front cover is formed to be less than 90 degrees, the frying oil absorbed in the filter paper or the accumulated sediments filtered by the filter paper are not spilled, so that a safety accident such as burns can be prevented.

The switchboard responsible for supplying electric power to the frying apparatus is provided at a lower portion of the main body to be rotatable forward and rearward, so that work can be made convenient by exposing the switchboard to the front when the apparatus is inspected.

### BRIEF DESCRIPTION OF DRAWINGS

FIG. 1 is a perspective view of a frying apparatus according to the present invention.

FIGS. 2a and 2b are cross-sectional views of the frying apparatus according to the present invention.

FIG. 3 is a front view of the frying apparatus according to the present invention.

FIG. 4 is a side view, a plan view, and a rear view of a frying oil tank according to the present invention.

FIGS. 5a and 5b are plan views for describing a heater according to the present invention.

FIG. 6 is a plan view of a circulation pipe according to the present invention.

FIG. 7 is a perspective view of main parts of the frying apparatus according to the present invention.

FIG. 8 is a view for describing an anti-loosening bolt of a height adjustment portion according to the present invention.

### REFERENCE SIGNS LIST

10: main body 11: first casing portion
12: second casing portion 13: front cover
14: upper cover 15: switchboard
16: support plate 17: side plate
20: oil tank 21: bottom surface
22: rear wall 23: side wall portion
24: heater 25: strainer
26: heater bracket 30: filter member
31: mesh basket 40: frying oil filtration unit
41: pump motor 42: circulation pipe
50: drain means 51: drain pipe
52: lever 53: drain basket
111: upper lid 121: bottom support portion
122: first magnet 131: support portion
151: second magnet 211: horizontal bottom portion
212: inclined bottom portion 213: inclined side wall portion
214: mounting hole 221: discharge port
222: supply port 241: heater rod
311: handle 312: stand
411: impeller 412: pumping housing
413: motor

### DESCRIPTION OF EMBODIMENT

The present invention can be subjected to various changes, and can have various forms, and an aspect (or an embodiment) will be described in detail in the text. However, it should understood that the present invention is not intended to being limited to a specific presented form and includes all changes, equivalents, and substitutes included in the concept and technical scope of the present invention.

In each drawing, the same reference signs, particularly reference signs with the same tens and ones digits, or the same tens and ones digits and alphabets denote members having the same or similar functions, and unless otherwise specified, a member denoted by each reference sign in the drawings can be understood as a member complying with these criteria.

In addition, in each drawing, in consideration of convenience of understanding or the like, components are exaggeratedly depicted as being large (or thick) or small (or thin) or are simplified in size or thickness; however, the scope of protection of the present invention should not be interpreted as being limited thereby.

The terms used in the present specification are merely used to describe a specific aspect (or an embodiment), and are not intended to limit the present invention. Unless explicitly indicating otherwise in context, singular expressions include plural expressions.

In the present application, it should be understood that the term such as “include” or “composed of” is intended to indicate the presence of features, numbers, steps, operations, components, parts, or combinations thereof described in the specification, and does not exclude the presence or possibility of addition of one or more other features, numbers, steps, operations, components, parts, or combinations thereof in advance.

Unless otherwise defined, all terms used herein, including technical or scientific terms, have the same meaning as generally understood by those skilled in the technical field to which the present invention pertains. Terms defined in commonly used dictionaries should be interpreted as having meanings consistent with the contextual meanings of the related technology and, unless explicitly defined in the present application, are not interpreted in an ideal or excessively formal sense.

The terms “first”, “second”, and the like described in the present specification are used only to distinguish between different components, are not restricted by the order in which the components are manufactured, and may not be consistent in names with those in the detailed description and claims of the invention.

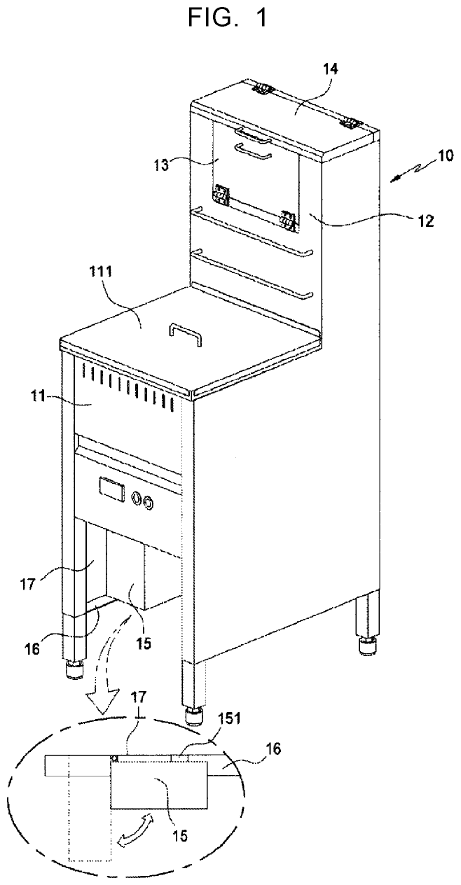

For convenience in describing a frying apparatus according to the present invention, when an approximate direction reference that is not strict is specified with reference to FIG. 1, upward, downward, leftward, and rightward directions are determined as seen with an acting direction of gravity set to downward, and in the detailed description and claims of the invention related to the other drawings, unless otherwise specified, directions are specified and described according to this reference.

Hereinafter, the frying apparatus according to the present invention will be described with reference to the accompanying drawings.

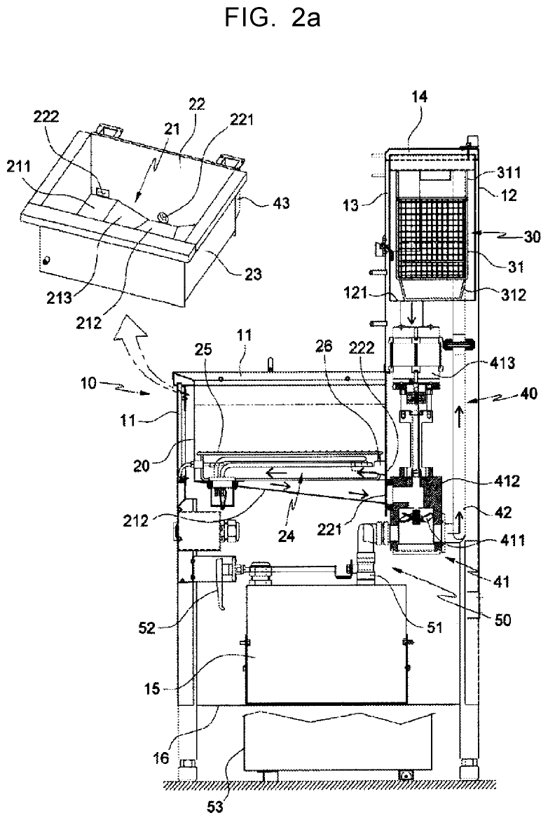

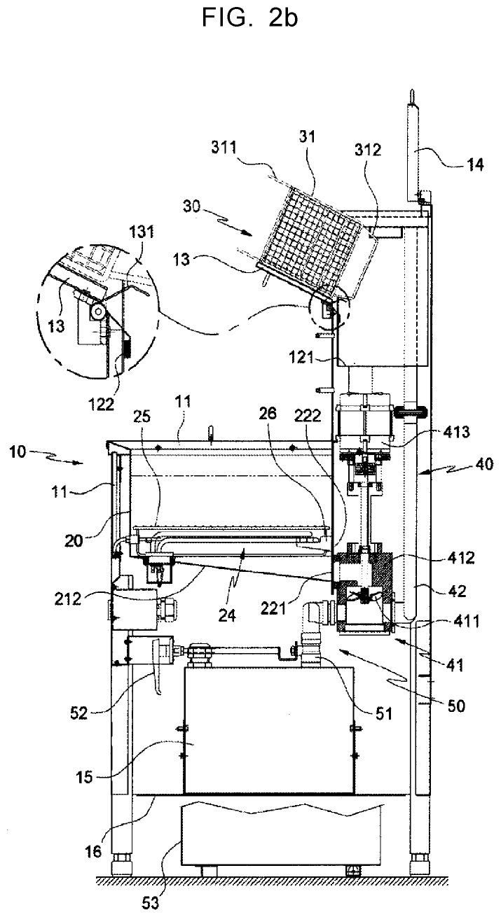

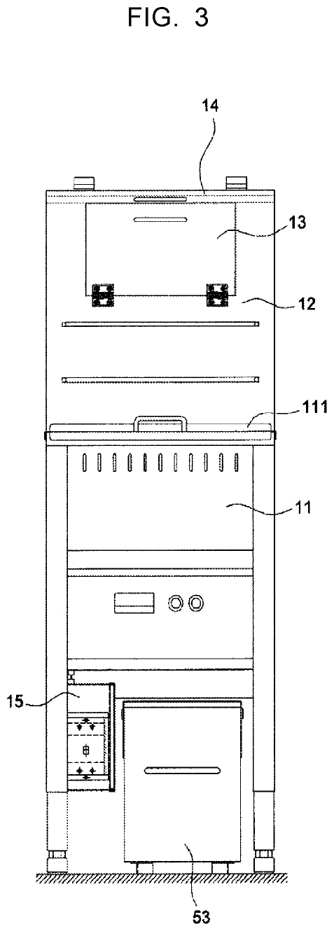

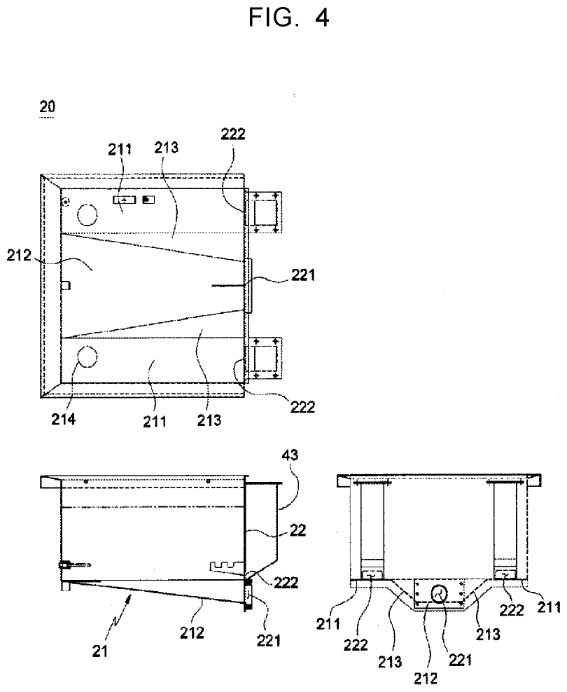

As shown in FIGS. 1 to 6, the frying apparatus according to the present invention mainly includes a main body (10), a frying oil tank (20), a filter member (30), a frying oil filtration unit (40), and drain means (50).

Specifically, the present invention includes
the main body (10) provided with a first casing portion (11) and a second casing portion (12) located behind and above the first casing portion (11);
the frying oil tank (20) installed in the first casing portion (11), and provided with a central discharge port (221) located close to a bottom surface of the frying oil tank (20), and with supply ports (222) arranged at upper portions of both sides of the discharge port (221);
the filter member (30) installed in the second casing portion (12); and
the frying oil filtration unit (40) provided with a circulation piping installed to connect the discharge port (221) and the supply ports (222) while passing through the filter member (30), and with a motor pump (41) that is installed on the circulation piping, and that suctions and pumps frying oil in the oil tank (20) to circulate and replenish the frying oil, which has passed through the filter member (30), into the oil tank (20).

The main body (10) is formed such that the first casing portion (11) can be opened and closed with an upper lid (111), the second casing portion (12) is connected to a rear upper portion of the first casing portion (11) through a frame and a side plate structure, and the frying oil filtration unit (40) is installed in a lower space of the second casing portion (12) on the rear side of the first casing portion (11).

The frying oil tank (20) is sealed on front, rear, left, right, and lower surfaces, excluding an upper surface, and a heater (24) is installed close to above a bottom surface (21) to heat the frying oil in the oil tank (20) to a high temperature, thereby cooking a fried dish in the oil tank (20).

The heater (24) of the present invention is in the form of triple heater rods (241).

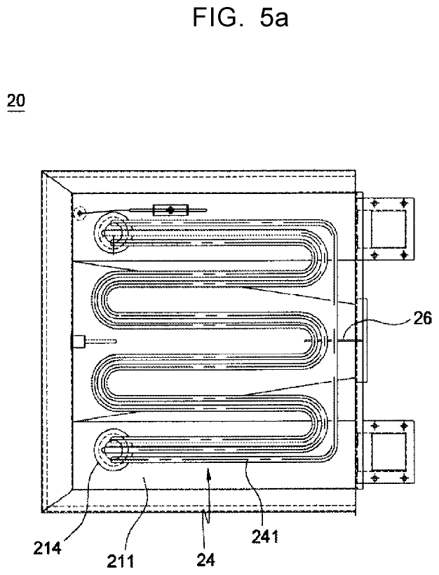

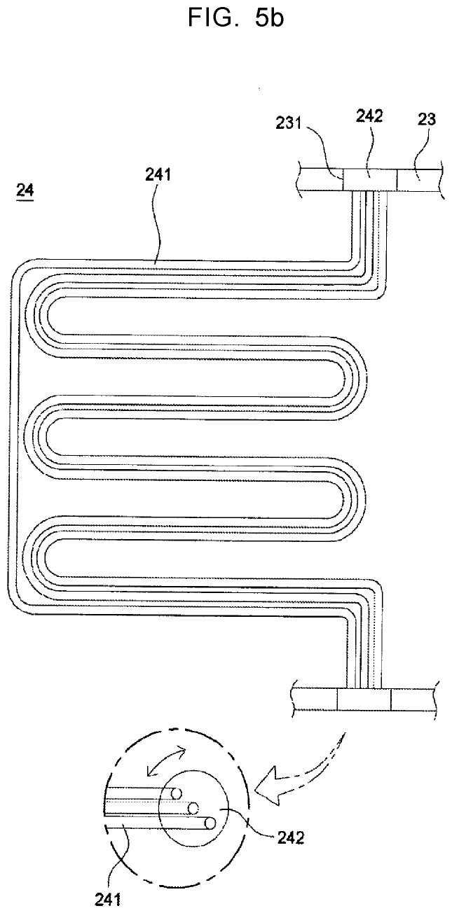

As shown in FIG. 5a, both ends of each heater rod (241) may be coupled to mounting holes (214) provided on the bottom surface (21) of the oil tank (20), and the entirety of the bottom surface (21) may be covered with the heater rods (241).

Alternatively, as shown in FIG. 5b, mounting holes (231) are provided on both side wall portions (23) of the oil tank (20), so that both ends of each heater rod (241) can be coupled to the mounting holes (231). In this case, rotating blocks (242) are rotatably provided in the mounting holes (231), so that the bottom surface (21) of the oil tank (20) can be cleaned in a state where the heater rods (241) are rotated upward.

The oil tank (20) is configured such that one central discharge port (221) and two supply ports (222) on both sides are provided at a lower end of a rear wall (22) and the discharge port (221) and the supply ports (222) are connected to the circulation piping of the frying oil filtration unit (40).

In this case, the bottom surface (21) of the oil tank (20) is characterized by including horizontal bottom portions (211) connected forward from the supply ports (222), an inclined bottom portion (212) connected in a manner as to be inclined downward and rearward toward the discharge port (221) between the horizontal bottom portions (211), and inclined side wall portions (213) connected in a manner as to be inclined downward and inward between the horizontal bottom portions (211) and the inclined bottom portion (212).

The horizontal bottom portions (211) are planar horizontal surfaces having a larger width than a left-right width of the supply ports (222), and cover both right and left sides of the bottom surface (21) of the oil tank (20) from the front to the rear.

The inclined bottom portion (212) is connected in a manner as to be inclined at a predetermined angle from a front end portion toward a rear end portion, and is connected to the discharge port (221). The inclined bottom portion (212) is formed in a structure in which the left-right width is wide at the front and narrow at the rear, and in this case, the left-right width of the rear end portion of the inclined bottom portion (212) is formed to be larger than that of the discharge port (221).

The inclined side wall portions (213) connect the right and left horizontal bottom portions (211) and the central inclined bottom portion (212), and are inclined downward and inward.

Accordingly, the frying oil suctioned into the discharge port (221) by the operation of the motor pump (41) to be described later is filtered for accumulated sediments while passing through the filter member (30), and then the filtered frying oil is circulated and replenished into the supply ports (222).

At this time, the frying oil on the bottom surface (21) of the oil tank (20) flows forward from the rear of both right and left sides of the oil tank (20) due to a discharge pressure generated at the supply ports (222), and then turns to the center at a front end of the oil tank (20) and flows from the front to the rear.

Accordingly, the accumulated sediments on the horizontal bottom portions (211) flow with the frying oil and are guided to the inclined bottom portion (212), or flow along the inclined side wall portions (213) and are collected on the inclined bottom portion (212). The accumulated sediments collected on the inclined bottom portion (212) in such a manner flow along the inclined bottom portion (212), and are suctioned into and discharged through the discharge port (221) along with the flow of the frying oil discharged by a suction pressure generated at the discharge port (221). Since the frying oil is filtered by discharging all the accumulated sediments in the oil tank (20), not only the fried dish can be prevented from deteriorating by keeping the frying oil clean for a longer period of time, but also the replacement period of the frying oil can be extended by reducing the contamination of the frying oil.

Reference sign 25 denotes a strainer that prevents the fried dish in the oil tank (20) from coming into direct contact with the heater rods (241) of the heater (24), and reference sign 26 denotes a heater bracket by which the heater rods (241) is held and supported.

The filter member (30) separates and filters the accumulated sediments discharged together from the frying oil that is caused to flow through the circulation piping by the motor pump (41).

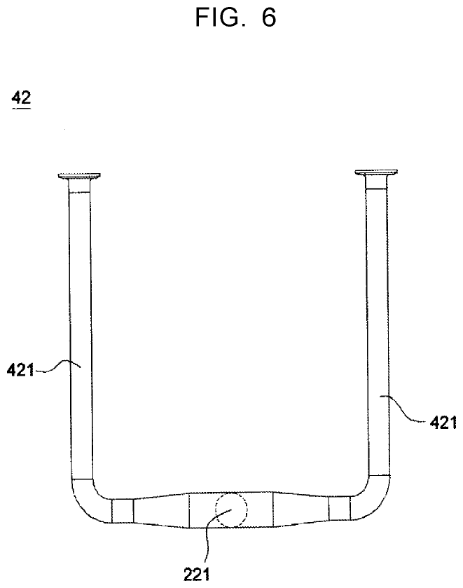

The filter member (30) includes a mesh basket (31) with an open upper surface and a filter paper (F and refer to FIG. 6) covered with the mesh basket (31), and is attachable to and detachable from the second casing portion (12).

The main body (10) is characterized by including covers (13) and (14) that open and close a front surface and an upper surface of the second casing portion (12).

The mesh basket (31) includes a handle (311) connected to an upper end of the mesh basket (31), and a stand (312) connected to a bottom surface of the mesh basket (31), and the stand (312) is supported and mounted on a bottom support portion (121) of the second casing portion (12).

The filter paper is in the form of a sheet of paper, cotton fabric, or the like, and filters the accumulated sediments by allowing only the frying oil to pass through fine pores, and the filter paper can be replaced.

In addition, both the front cover (13) and the upper cover (14) of the second casing portion (12) are provided to be hinge-coupled to the second casing portion (12) through a hinge and to be rotatably opened and closed.

In this case, a lower end of the front cover (13) is hinge-coupled to the second casing portion (12), and the front cover (13) is openable and closable by rotating upward and downward.

A rear end portion of the upper cover (14) is hinge-coupled to the second casing portion (12), and the upper cover (14) can be opened and closed by rotating upward and downward.

Particularly, the front cover (13) is characterized in that the downward opening angle is limited to less than 90 degrees and a support portion (131) that supports and holds the filter member (30) is provided at the lower end.

The opening angle of the front cover (13) is limited to less than 90 degrees, more preferably less than 80 degrees, by a separate stopper.

The support portion (131) is bent inward to protrude from the lower end of the front cover (13), and when the front cover (13) and the upper cover (14) are opened and then the filter member (30) is taken out while being inclined forward, the mesh basket (31) is caught and held on the support portion (131).

At this time, since the downward rotation opening of the front cover (13) is limited to 90 degrees, more preferably less than 80 degrees, the filter member (30) is not completely laid forward, so that a safety accident such as burns due to the accumulated sediments filtered by the filter paper (F) or the frying oil absorbed in the filter paper (F) being spilled forward is prevented from occurring.

In a state where the frying oil remaining in the filter paper (F) naturally falls and is discharged due to the inclination of the front cover (13), the entirety of the filter member (30) or only the filter paper (F) can be removed, and the accumulated sediments can be separated and discharged.

At this time, the second casing portion (12) includes a first magnet (122) built into a portion with which the support portion (131) comes into contact, so that the front cover (13) is prevented from being opened unintentionally.

The circulation piping includes a circulation pipe (42) that connects between the motor pump (41) and the second casing portion (12), and a supply pipe (not shown) that connects between the second casing portion (12) and the first casing portion (11).

In this case, the circulation pipe (42) is coupled to a pumping housing (412) of the motor pump (41) connected to the discharge port (221), and includes branch pipes (421) branched to both sides and connected upward, and each branch pipe (421) is connected to an upper end portion of the second casing portion (12), so that the frying oil and the accumulated sediments are widely dispersed and input to the filter member (30).

The supply pipe is in the form of two separate pipes, and an upper end and a lower end of each supply pipe are connected to discharge holes formed on both sides of the bottom support portion (121) of the second casing portion (12) and to the supply ports (222), and the filtered frying oil is circulated and replenished into the oil tank (20). In the drawing, as portions to which the supply pipe (not shown) is connected, supply pipe connection portions (43) coupled to both sides of the rear surface of the oil tank (20) by welding can be observed.

The motor pump (41) includes the pumping housing (412) connected to the discharge port (221) and including a built-in impeller (411), and a pumping housing (412), and a motor (42) installed on an upper portion of the pumping housing (412) and rotating the impeller (411).

A suction pressure is generated inside the pumping housing (412) by the rotation of the impeller (411) upon operation of the motor (42), and the frying oil in the oil tank (20) is suctioned, discharged, and pumped into the second casing portion (12) through the circulation pipe (42).

Therefore, as described above, a suction pressure is generated at the discharge port (221) by the operation of the motor pump (41), and a discharge pressure is generated at the supply ports (222) due to falling of the frying oil, so that the filtration of the frying oil is performed while the frying oil in the oil tank (20) circulates in a filtered state through the filter member (30).

In addition, the main body (10) includes a switchboard (15).

The switchboard (15) is characterized in that one end of the switchboard (15) is hinge-coupled to one lower side of the first casing portion (11) and the switchboard (15) is rotatable forward and rearward.

The switchboard (15) is a type of control board for supplying electric power to the frying apparatus, and rotates in a front-rear opening/closing manner with a front end portion on the one side provided as a rotation axis.

In this case, in the main body (10), a support plate (16) is connected between front and rear frames disposed in a direction in which the switchboard (15) is provided, and the support plate (16) constantly supports a part of a bottom portion of the switchboard (15), so that damage due to load imbalance of the switchboard (15) is prevented.

In addition, a second magnet (151) that is attachable to a side plate (17) connected to an upper portion of the support plate (16) is mounted on the switchboard (15), so that the switchboard (15) attached to the side plate (17) is prevented from unintentionally rotating forward.

During use of the frying apparatus, by rotating the switchboard (15) rearward to bring the switchboard (15) into close contact with the side plate (17) of the main body (10), the frying apparatus can be made convenient to use, and when the apparatus is inspected or components are replaced, by rotating the switchboard (15) forward to expose a front surface thereof, inspection work or the like can be made very convenient.

In addition, the present invention includes the drain means (50) for removing or replacing the frying oil in the oil tank (20).

The drain means (50) includes a drain pipe (51) connected to a lower portion of the pumping housing (412) and including a built-in valve (typically, a ball valve); a lever (52) for opening and closing the valve; and a drain basket (53) in which frying oil discharged to the drain pipe (51) is stored.

Therefore, when the valve of the drain pipe (51) is opened using the lever (52) in a state where the motor pump (41) is stopped, the frying oil in the oil tank (20) flows along the structure of the bottom surface (21) of the oil tank (20), the bottom surface (21) being inclined downward, and is completely discharged to the drain basket (53) through the drain pipe (51).

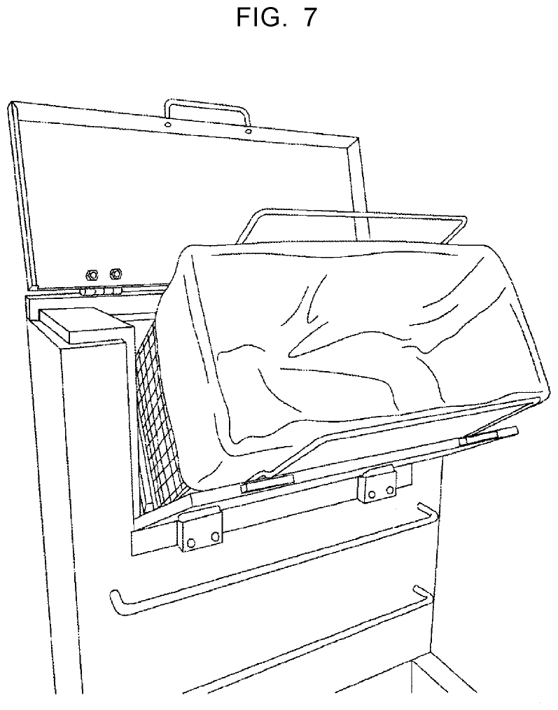

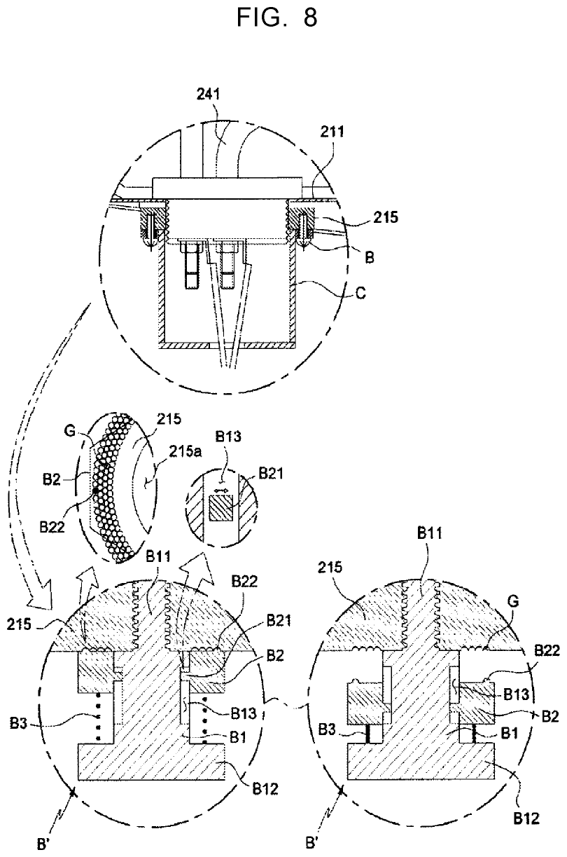

Meanwhile, as shown in FIG. 7, the heater (24) is mounted by inserting a flange, to which the end of each heater rod (241) is connected, inserted into the bottom surface (21) of the oil tank (20), and a heater cover (C) covers the end of each heater rod (241) and is coupled to a mounting block (215) of the oil tank (20) with bolts (B) to protect an electric wire connected to each heater rod (241). The bolts (B) may become loosened due to vibration of the motor pump (41) or the like, and the heater cover (C) may be separated.

Accordingly, the present invention solves the above-described problem by introducing an anti-loosening bolt (B′) having a structure different from that of the general bolt (B).

First, the mounting block (215) is provided with locking grooves (G) arranged in multiple rows along a circumferential direction of a threaded hole (215a) to which the anti-loosening bolt (B′) is fastened.

The anti-loosening bolt (B′) includes
a bolt body (B1) provided with a threaded portion (B11) fastened to the threaded hole (215a), and a head portion (B12) on a rear end side, and provided with a sliding groove (B13) formed in a longitudinal direction on an outer peripheral surface in front of the head portion (B12);
a binding member (B2) inserted onto the bolt body (B1), and provided with a guide projection (B21) protruding from an inner peripheral surface and fitting into the sliding groove (B13), and with a locking projection (B22) protruding from a front surface and fitting into one of the locking grooves (G); and
a compression spring (B3) interposed between the head portion (B12) and the binding member (B2) to press the binding member (B2) forward.

The bolt body (B1) has a columnar shape with a predetermined front-rear length in which the threaded portion (B11) protrudes forward and is connected and the head portion (B12) is connected on the rear end side.

This bolt body (B1) is rotatable with the threaded portion (B11) fastened to the threaded hole (215a), and at this time, the bolt body (B1) rotates together with the binding member (B2).

The binding member (B2) has a hexagonal nut shape, and is rotatable together with the bolt body (B1) due to the guide projection (B21).

In this case, a width of the sliding groove (B13) is formed to be wider than a width of the guide projection (B21), so that only the binding member (B2) is freely rotatable at a predetermined angle with respect to the bolt body (B1).

A plurality of the locking projections (B22) are arranged in a circular shape along the front surface of the binding member (B2).

When no external force is applied, the compression spring (B3) biases the binding member (B2) forward to force the binding member (B2) to come into close contact with the mounting block (215).

The anti-loosening bolt (B′) can be tightened or untightened by rotating the bolt body (B1) leftward or rightward in a state where the binding member (B2) is held and pulled rearward using a monkey wrench or a vice plier, due to the locking structure of the sliding groove (B13) and the guide projection (B21).

Accordingly, when the anti-loosening bolt (B′) is tightened in a state where the binding member (B2) is pulled, the anti-loosening bolt (B′) is tightened while the bolt body (B1) comes into close contact with the mounting block (215), so that the heater cover (C) is fixed.

When the binding member (B2) is released after tightening is completed, the binding member (B2) comes into close contact with the mounting block (215) due to the elastic force of the compression spring (B3), and one of the locking projections (B22) is inserted and locked to one of the locking grooves (G), so that the bolt body (B1) is restrained by the binding member (B2). Therefore, the rotation of the bolt body (B1) is restrained unless the locking projection (B22) comes out of the locking groove (G), so that the loosening of the anti-loosening bolt (B′) due to vibration or the like is prevented.

In this case, depending on the tightening angle, the locking projection (B22) may not be accurately aligned with one of the locking grooves (G); however, according to the present invention, since only the binding member (B2) is independently rotatable due to a play between the sliding groove (B13) and the guide projection (B21), by adjusting the angle of the binding member (B2) when the binding member (B2) is released after the bolt body (B1) is tightened, the locking projection (B22) can be inserted into the locking groove (G).

In the above description of the present invention, the frying apparatus has been mainly described with reference to the accompanying drawings; however, it should be interpreted that various modifications, changes, and substitutions can be made to the present invention by those skilled in the art, and such modifications, changes, and substitutions fall within the scope of protection of the present invention.

1. A frying apparatus characterized by comprising:
a main body provided with a first casing portion and a second casing portion located behind and above the first casing portion;
a frying oil tank installed in the first casing portion, and provided with a central discharge port located close to a bottom surface of the frying oil tank, and with supply ports arranged at upper portions of both sides of the discharge port;
a filter member installed in the second casing portion; and
a frying oil filtration unit provided with a circulation piping installed to connect the discharge port and the supply ports while passing through the filter member, and with a motor pump that is installed on the circulation piping, and that suctions and pumps frying oil in the oil tank to circulate and replenish the frying oil, which has passed through the filter member, into the oil tank.

2. The frying apparatus according to claim 1 characterized in that
the filter member includes a mesh basket and a filter paper covered with the mesh basket, and is attachable to and detachable from the second casing portion, and
the main body includes covers that open and close a front surface and an upper surface of the second casing portion.

3. The frying apparatus according to claim 2 characterized in that,
a lower end of the front cover of the second casing portion is hinge-coupled to the second casing portion, so that the front cover is openable and closable by rotating upward and downward,
a downward opening angle of the front cover is limited to less than 90 degrees, and
a support portion that supports and holds the filter member is provided at the lower end.

4. The frying apparatus according to claim 1 characterized in that,
the bottom surface of the oil tank includes horizontal bottom portions connected forward from the supply ports, an inclined bottom portion connected in a manner as to be inclined downward and rearward toward the discharge port between the horizontal bottom portions, and inclined side wall portions connected in a manner as to be inclined downward and inward between the horizontal bottom portions and the inclined bottom portion.
